(19) United States
(12) Patent Application Publication
(10) Pub. No.: US 2025/0137865 A1
(43) Pub. Date: May 1, 2025

(54) Universal Mounting System for a Wheel Balancer

(71) Applicant: Allan Hjorth Hansen, Panama City (PA)

(72) Inventor: Allan Hjorth Hansen, Panama City (PA)

(21) Appl. No.: 18/932,333

(22) Filed: Oct. 30, 2024

Related U.S. Application Data
(60) Provisional application No. 63/546,500, filed on Oct. 30, 2023.

(51) Int. Cl. G01M 1/04

(52) U.S. Cl. CPC G01M 1/045

(57) ABSTRACT

A universal mounting system for a wheel balancer is a system that facilitates the mounting of a wheel to a wheel balancer in such a way that gravity effects are eliminated by utilizing the captured spring in the wheel balancer hub. The system includes a spacer disk and a spring extension. The spacer disk is designed to accommodate the spring extension in such a way that the spacer disk can directly and/or indirectly engage the captured spring in the wheel balancer hub. The spacer disk is also designed to accommodate a low-tapered cone or collet as well as the stud nipples of spring-loaded studs used with a centering plate to secure and center the selected wheel to the wheel balancer shaft. The spring extension is designed to enable the indirect engagement of the cone or collet being used with the captured spring on the wheel balancer hub.

The current application claims a priority to the U.S. provisional patent application Ser. No. 63/546,500 filed on Oct. 30, 2023.

### FIELD OF THE INVENTION

The present invention relates generally to wheel balancers and wheel accessories. More specifically, the present invention discloses a system that enables a selected wheel to be efficiently mounted onto a wheel balancer in such a way that the effects of gravity are reduced to improve the balance accuracy of the desired wheel.

### BACKGROUND OF THE INVENTION

In general, vehicle wheels are best balanced using a conical device (e.g., a cone or collet) that centers the wheel on a wheel balancer shaft. In addition, a clamping tool is used to secure the wheel to the wheel balancer hub. Often the clamping tool includes a spring-loaded mechanism which allows automatic compensation for any inaccuracy in the stud device as well as thickness variations in the wheel itself. The clamping tool serves as the “dynamic torquing” device that forces the wheel to sit straight on the wheel balancer and the cone/collet serves as the “static centering” device that centers the wheel exactly on the wheel balancer shaft while trying to overcome the effects of gravity. This combination works great on standard car wheels and pickup truck wheels due to the low weight, up to and around 80 pounds (lbs.). For heavy commercial wheels, a wheel balancer system utilizes a centering disk that has the diameter of the truck hub and a centering plate with studs, and wherein the studs have an expanded nipple that leans on the spacer disk. The centering plate has a large manufacturing specification in the center bore of the wheel. The disk also has a large tolerance, though not near as large as the plate. As a result, the centering disk only pre-centers the wheel, and the studs with the nipples end up doing the final centering which achieves an adequate result. Due to the play between the wheel bore and centering disk, gravity causes the wheel to drop while being centered. If the wheel is mounted the exact same way on the vehicle, then the wheel rotates reasonably well down the road at speed. However, if the wheel is mounted differently, which it commonly is, then the wheel rotates in an ovular path. The worst-case scenario is the wheel mounted with the valve stem positioned along the bottom, which results in the play being doubled and the vehicle shaking like crazy when driven at speed, especially when reaching 70 Miles per Hour (MPH). These unwanted harmonics have resulted in truck owners adding various compounds inside the tire instead of balancing. These compounds dampen the vibration caused by the imbalance, but the compounds do not balance the wheel.

Moreover, as medium trucks have become more popular over the years using light truck tires, often referred to as LLKW or Light Commercial and Motorhome (LCM) wheels, the old wheel balancing heavy commercial system was shrunk to fit these wheels which usually weigh around 80 to 150 lbs. Many of these wheels are found on Class 3 to Class 5 trucks but also on small pickup trucks, SUVs, and passenger cars. There is a large aftermarket industry for selling huge and heavy wheels to passenger cars or pickup trucks. In other words, the overall weight of the wheel is a bigger issue than which vehicles the wheel can fit in. For LCM wheel balancing, a centering plate is used with holes to connect the studs to. The centering plate has the same bolt pattern as the wheel. Further, the spacer disk has an area for the stud nipple to rest on, that has the exact wheel dimension (bolt pattern) minus the diameter of the stud nipple, usually milled to max tolerance of 0.020 millimeters (mm) on the diameter. For example, a Ford F450 wheel has a bolt pattern Pitch Circle Diameter (PCD) of 10×225 mm. That means ten lug holes located and evenly divided on a 225 mm diameter. Five rim holes are drilled in the centering plate to usually ten-micron of accuracy between the stud and the hole in the centering plate. The spacer disk is milled to a diameter of 211 mm (225 mm minus the 14 mm diameter of the stud nipple). On heavy commercial trucks (e.g., 18-wheelers) the stud nipple is usually 17 mm. Furthermore, a small gain can usually be achieved by using a spring-loaded stud due to the variance in the wheel material thickness. The centering plate and the spacer disk work for all the various bolt patterns and center hole diameters as needed. Just like the issue with heavy commercial wheels, the play between the center bore of the wheel and the centering disk is relatively large providing less than perfect balancing results. The vehicles in question are often more sensitive to vibration than heavy commercial vehicles, so the problem has been growing.

An alternative idea has been used for light commercial and motorhome wheels up to about 150 lbs. weight for a few years. The alternative idea consists of a spacer disk and a collet with a usually low angle. The collet is forced into the center bore of the wheel by the spring located inside the hub of the balancer (most balancers now have captured springs, meaning that the spring is covered by a plastic or steel plate). Because the collet needs the spring to work, it is not possible to use a spacer disk that is located and centered on the precision balancer shaft. Instead, the spacer disk is located on the outer diameter of the wheel balancer hub's faceplate. The problem with that solution is that the hub does not have the required accuracy to use studs with a nipple. The play between the wheel balancer hub and the inner diameter of the spacer disk is simply far too high. There are hundreds of thousands of wheel balancers in use every day around the world, few of which have an accurate hub outer diameter. As a result, the spacer disk serves mainly to make room for the collet. Even though a centering plate with studs is used in combination, virtually all the centering is now done by the collet. This alternate system is cheaper to manufacture compared to the above systems with many centering disks and a little easier for the operator to use; however, this system is generally less accurate. In fact, on many wheels, this alternate system is usually less accurate.

Therefore, an objective of the present invention is to provide a system that correctly balances LCM and heavy commercial vehicle wheels. The present invention provides a system that allows the spacer disk to be in contact with the wheel balancer hub spring, either directly or indirectly. This allows the use of a cone and/or collet to help center the wheel on the wheel balancer shaft. Another objective of the present invention is to facilitate the use of a centering plate and studs with extended nipples with the cone and/or collet to further assist the optimal centering of the wheel. The system of the present invention allows the studs to be positioned around the cone and/or collet so that each stud can lean back on the spacer disk for optimal centering. Additional features and benefits of the present invention are further discussed in the sections below.

### SUMMARY OF THE INVENTION

The present invention discloses a universal mounting system for a wheel balancer. The system of the present invention takes advantage of a balancer spring for optimal centering of the wheel being balanced. The system of the present invention is compatible with virtually all wheel balancer brands and models. To do so, the system of the present invention facilitates the direct interfacing of the spacer disk with the spring built into the wheel balancer hub. This allows the present invention to take full advantage of the fairly linear and correct spring pressure. Since the spacer disk is still centered on the precision balancer shaft, the system also allows the use of a centering plate and the corresponding studs with expended nipples. The system of the present invention further enables the use of low-tapered cones and/or collets that help center the wheel on the wheel balancer shaft. The low-tapered cones/collets enable the engagement of the stud nipples with the spacer disk. The balancing results are simply superior on medium wheels in the 80 pounds (lbs.) to 150 lbs. range (and may also work on the 300+ lbs. heavy commercial wheels).

### BRIEF DESCRIPTION OF THE DRAWINGS

FIG. 1 is a top-front-left perspective view of the present invention, wherein the spring extension is shown attached to the spacer disk.

FIG. 2 is a bottom-rear-right perspective view of the present invention thereof.

FIG. 3 is a front view of the present invention thereof.

FIG. 4 is a rear view of the present invention thereof.

FIG. 5 is a top-front-right exploded perspective view of the present invention thereof.

FIG. 6 is a bottom-rear-left exploded perspective view of the present invention thereof.

FIG. 7 is a top-front-left perspective view of the centering collet of the present invention.

FIG. 8 is a bottom-rear-right perspective view of the centering collet of the present invention.

FIG. 9 is a top-front-right exploded perspective view of the present invention, wherein a centering plate, a plurality of spring-loaded studs, a wheel balancer hub, and a wheel balancer shaft are shown.

FIG. 10 is a right-side view of the present invention, wherein the system of the present invention is shown with a wheel rim.

FIG. 11 is a front view of the present invention thereof.

FIG. 12 is a horizontal cross-sectional view of the present invention taken along line 12-12 in FIG. 11.

### DETAILED DESCRIPTION OF THE INVENTION

All illustrations of the drawings are for the purpose of describing selected versions of the present invention and are not intended to limit the scope of the present invention.

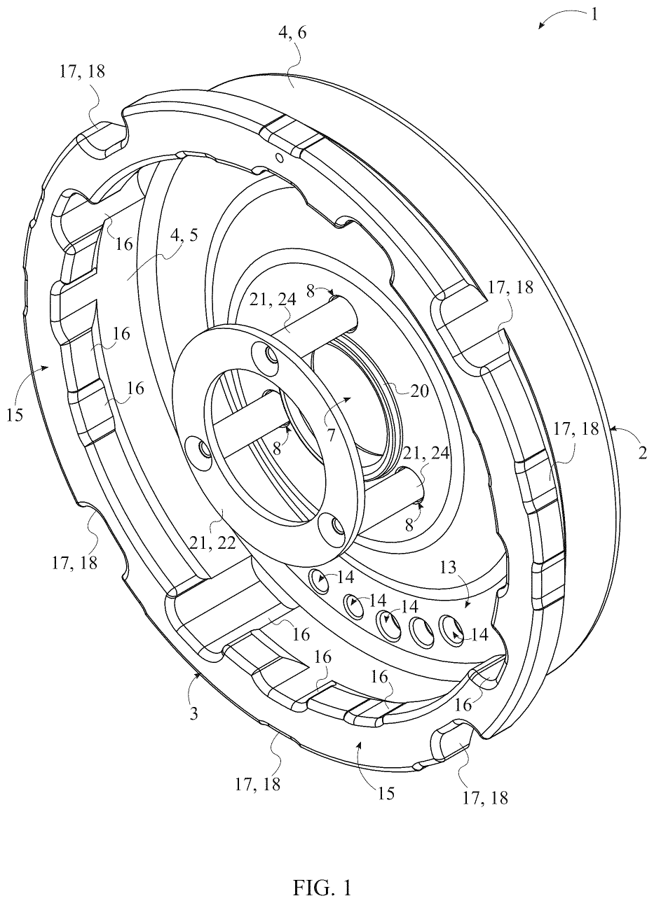

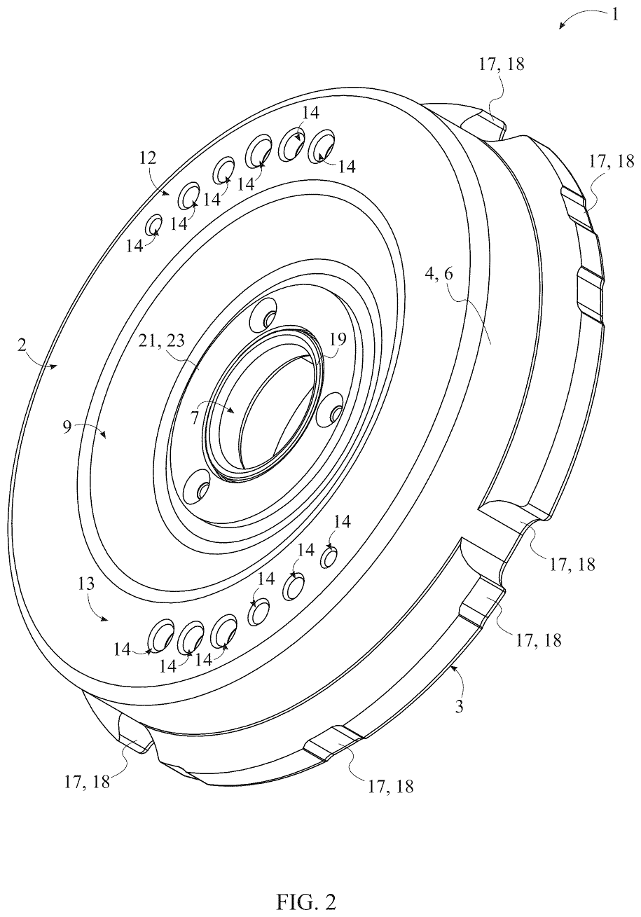

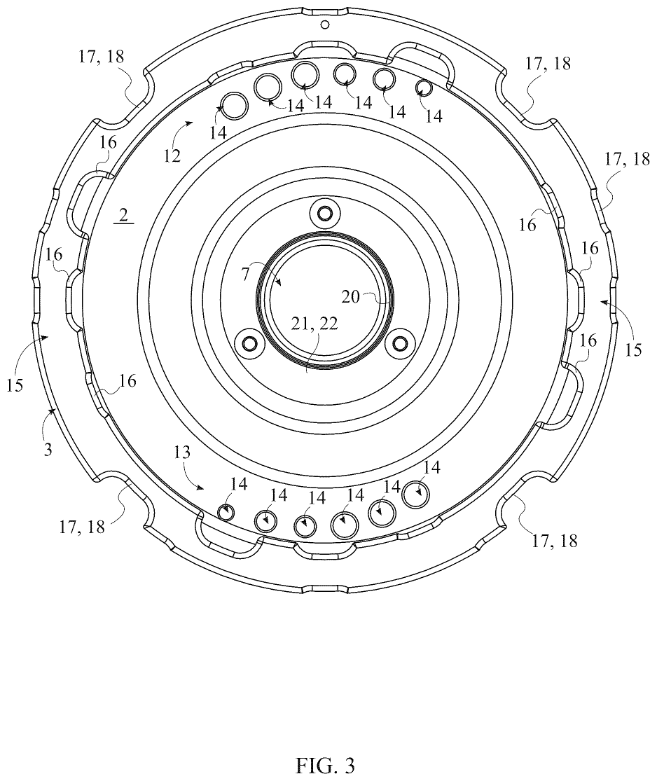

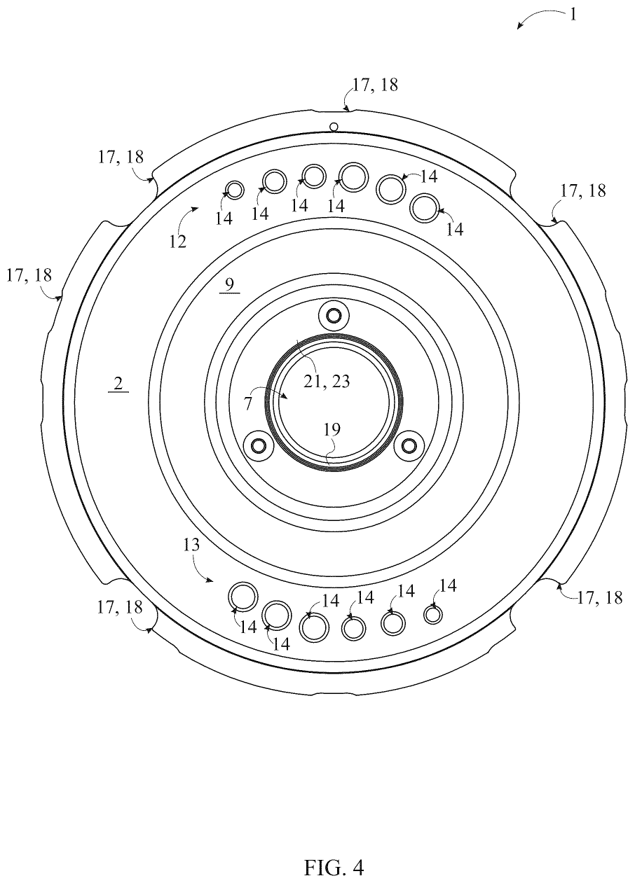

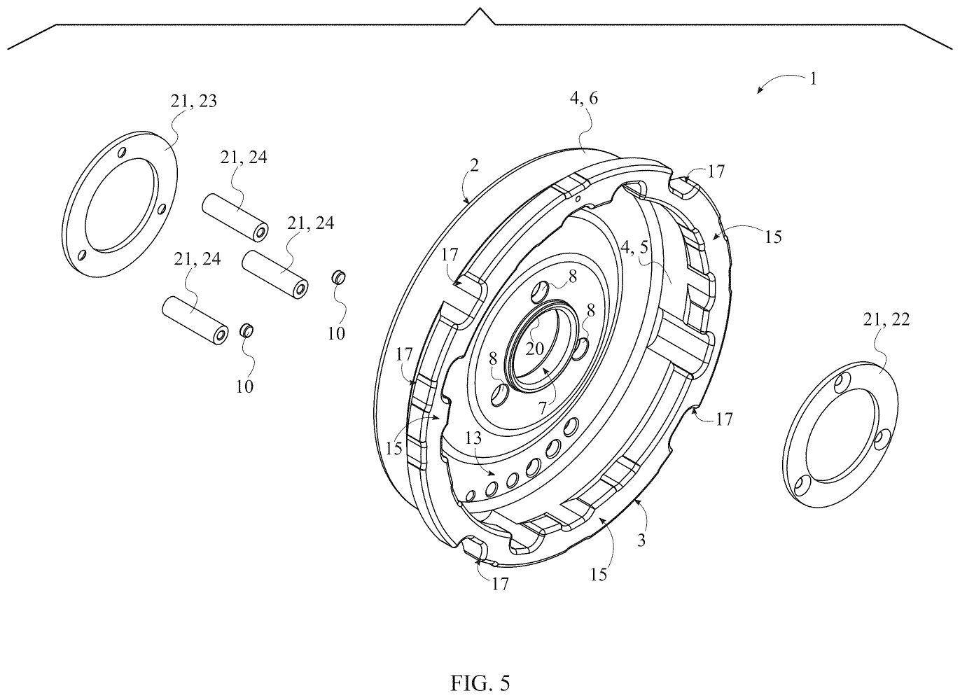

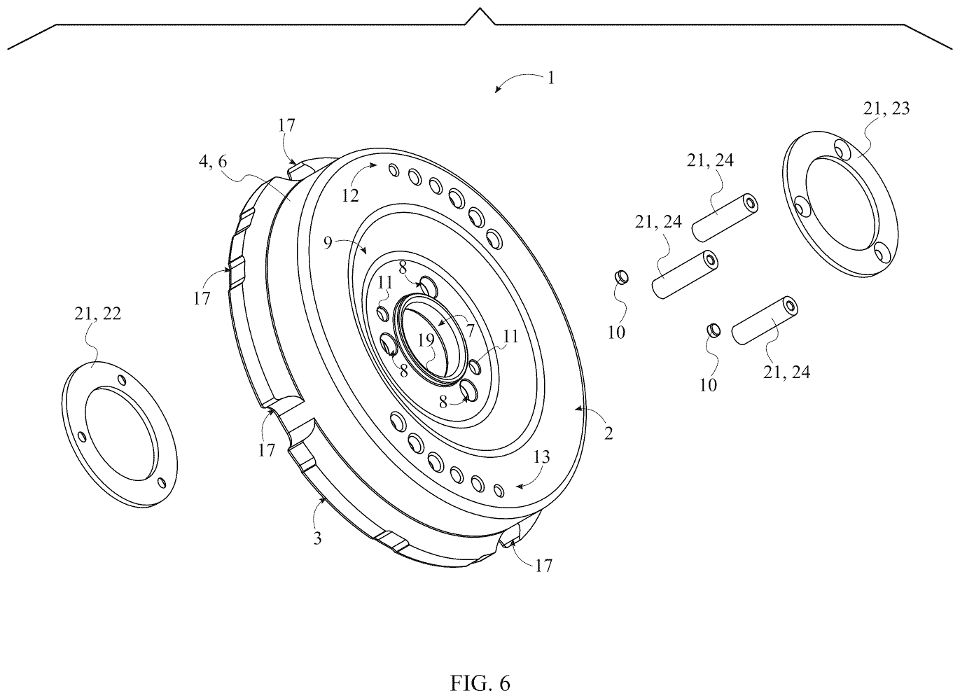

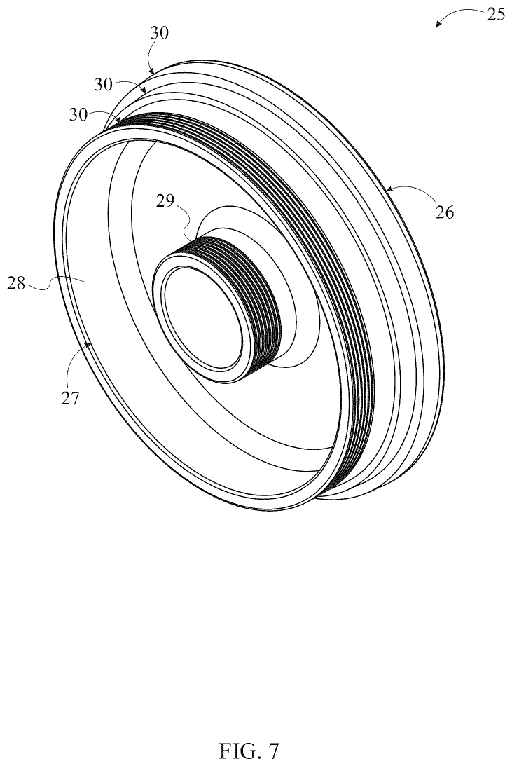

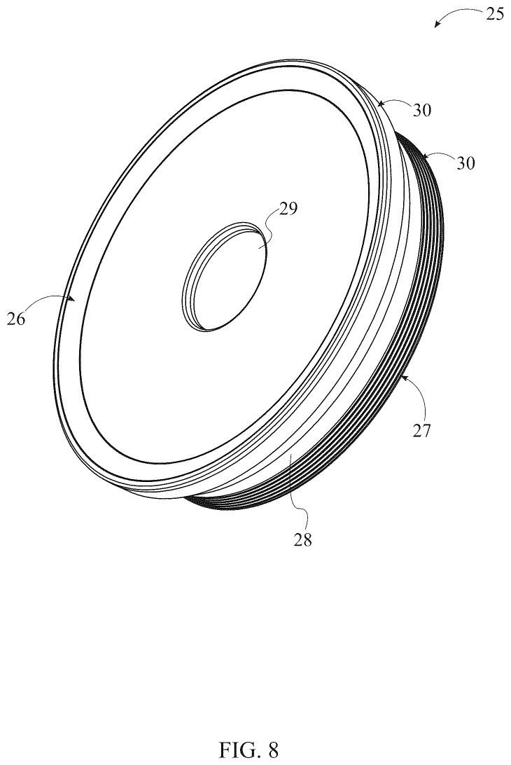

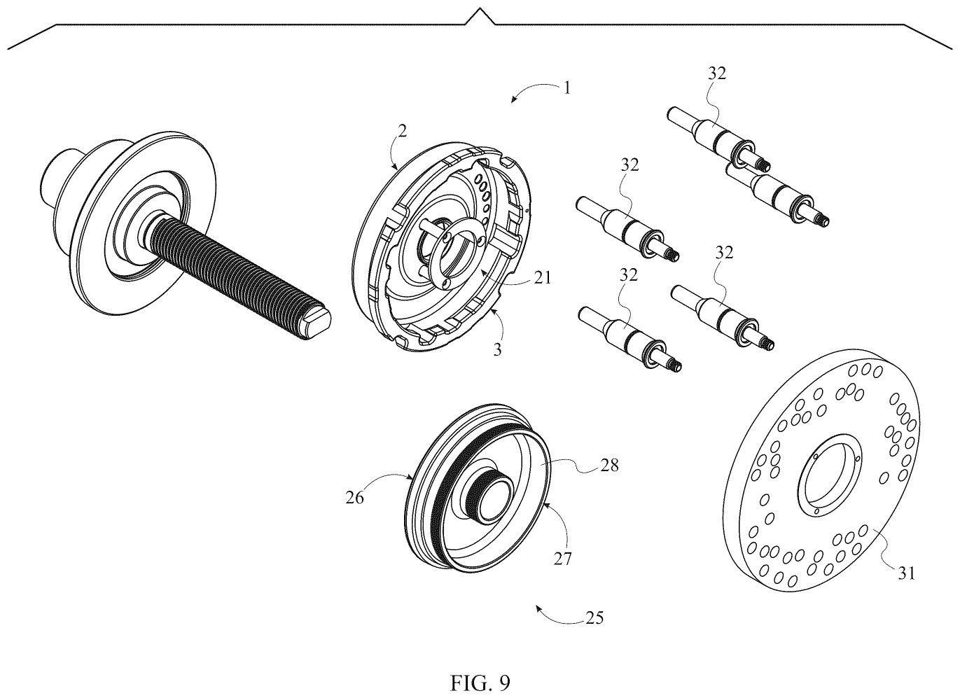

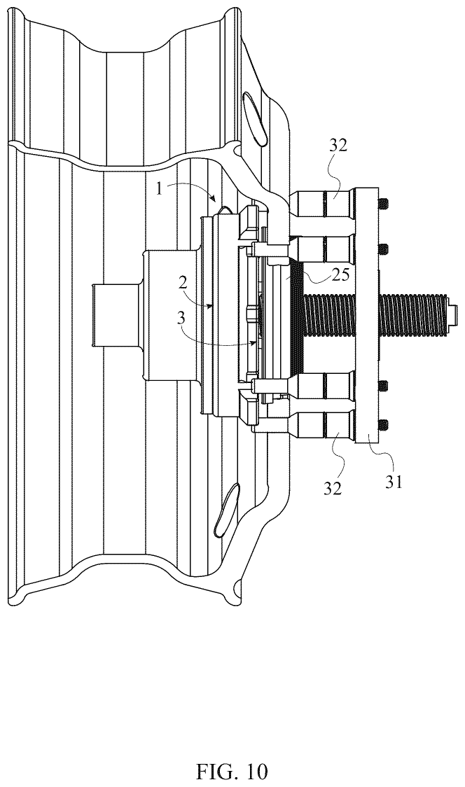

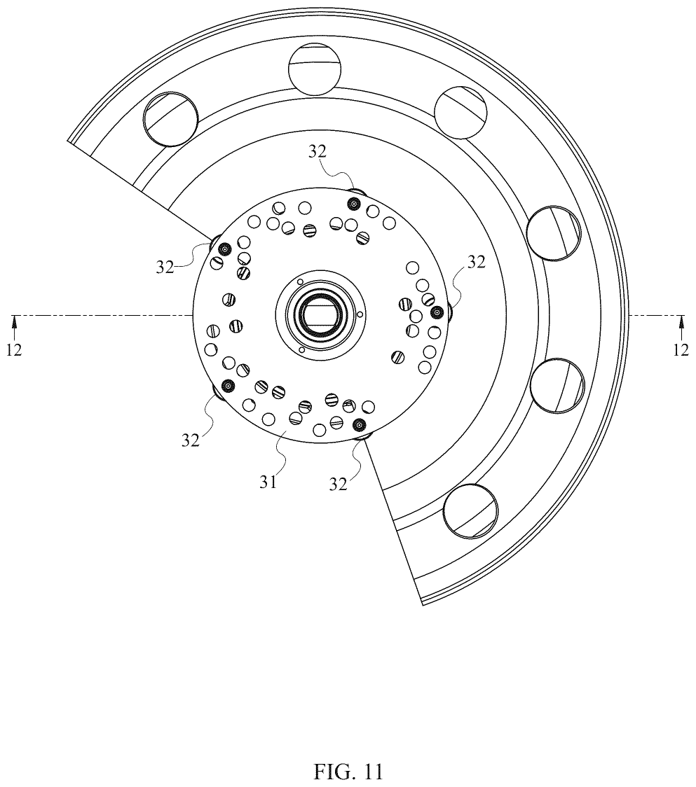

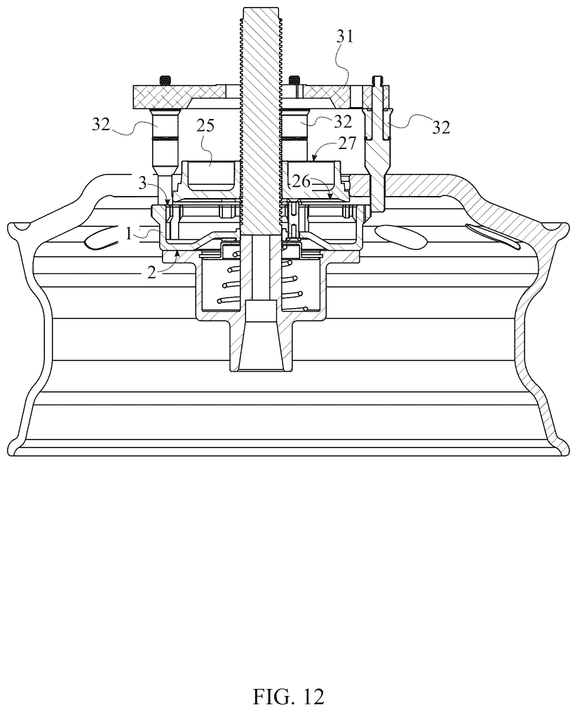

The present invention discloses a universal mounting system for a wheel balancer. The system of the present invention facilitates the mounting of a wheel to a wheel balancer in such a way that gravity effects are eliminated by utilizing the spring captured in the wheel balancer hub. As can be seen in FIGS. 1 through 12, the present invention comprises a spacer disk 1 and a spring extension 21. The spacer disk 1 is designed to accommodate the spring extension 21 in such a way that the spacer disk 1 can directly and/or indirectly engage the captured spring in the wheel balancer hub. The spacer disk 1 is also designed to accommodate a low-tapered cone or collet as well as the stud nipples of a plurality of spring-loaded studs 32 used with a centering plate 31 to secure and center the selected wheel to the wheel balancer shaft. The spring extension 21 is designed to enable the indirect engagement of the cone or collet being used with the captured spring on the wheel balancer hub.

The general configuration of the aforementioned components enables the optimal balancing of a selected wheel using an existing wheel balancer. As can be seen in FIGS. 1 through 12, the spacer disk 1 is designed to be used with different existing wheel balancers and can accommodate wheels of different sizes. The spacer disk 1 is forged, through-hardened, and then machined in hardened condition to obtain the best surface finish and tightest tolerances. The spacer disk 1 is then surface hardened to make the spacer disk 1 even more dent resistant and rustproof. This ensures optimal balancing results and a very long lifespan, during which balancing accuracy is always maintained. To do so, the spacer disk 1 comprises a closed disk base 2, an open disk base 3, a lateral disk wall 4, a shaft-receiving hole 7, and a plurality of spacer-receiving holes 8. The closed disk base 2 corresponds to the portion of the spacer disk 1 that engages the wheel balancer hub. The open disk corresponds to the portion that accommodates the cone or collet as well as the stud nipples used with the centering plate 31. The lateral disk wall 4 corresponds to the lateral portion of the spacer disk 1 that connects the closed disk base 2 to the open disk base 3. The shaft-receiving hole 7 enables the mounting of the spacer disk 1 to the wheel balancer shaft. Further, the plurality of spacer-receiving holes 8 corresponds to several openings that enable the mounting of the spring extension 21 to the spacer disk 1.

As previously discussed, the spring extension 21 facilitates the engagement of the captured spring in the wheel balancer hub with the spacer disk 1 and the cone/collet being used. As can be seen in FIGS. 1 through 12, the spring extension 21 comprises a proximal support ring 22, a distal support ring 23, and a plurality of elongated spacers 24. The proximal support ring 22 corresponds to the portion of the spring extension 21 that engages the cone/collet being used. The distal support ring 23 corresponds to the portion that engages the captured spring in the wheel balancer hub. Further, the plurality of elongated spacers 24 corresponds to several elongated structures that separate the proximal support ring 22 from the distal support ring 23 while facilitating the mounting of the spring extension 21 to the spacer disk 1. For example, the plurality of elongated spacers 24 can include, but is not limited to, several cylindrical rods large enough to offset the proximal support ring 22 from the distal support ring 23. The plurality of spacer-receiving holes 8 provides several holes on the closed disk base 2 large enough and in a pattern that accommodates the plurality of elongated spacers 24. For example, the plurality of spacer-receiving holes 8 each has a shape and size that matches the cross-sectional shape and size of the corresponding elongated spacers. Alternatively, the plurality of spacer-receiving holes 8 each corresponds to a large weight-reducing hole on the closed disk base 2 designed to reduce the overall weight of spacer disk 1. The weight-reducing holes are also arranged to match the pattern of the plurality of elongated spacers 24 and provide a space to engage the corresponding elongated spacer of the plurality of elongated spacers 24.

In the preferred embodiment, the present invention can be arranged as follows: the closed disk base 2 and the open disk base 3 are positioned opposite to each other about the lateral disk wall 4 due to the short cylindrical shape of the spacer disk 1, as can be seen in FIGS. 1 through 12. The overall size of the spacer disk 1 is determined based on the wheel balancers as well as the range of wheel sizes that the system of the present invention can be used with. Further, the shaft-receiving hole 7 and each of the plurality of spacer-receiving holes 8 traverses through the closed disk base 2. This way, the spacer disk 1 is mounted on the wheel balancer shaft from the closed disk base 2, and the spring extension 21 can be secured to the closed disk base 2 of the spacer disk 1. The shaft-receiving hole 7 is centrally positioned on the closed disk base 2 so that the spacer disk 1 is axially aligned with the wheel balancer shaft. Further, the plurality of spacer-receiving holes 8 is positioned around the shaft-receiving hole 7. In addition, the distal support ring 23 and the proximal support ring 22 are concentrically positioned to the shaft-receiving hole 7. This way, the spring extension 21 does not obstruct the mounting of the spacer disk 1 to the wheel balancer shaft.

As can be seen in FIGS. 1 through 12, the distal support ring 23 is positioned external to the spacer disk 1 and is mounted adjacent to the closed disk base 2 to enable the distal support ring 23 to engage the captured spring in the wheel balancer hub. On the other hand, the proximal support ring 22 is positioned within the spacer disk 1 so that the proximal support ring 22 can engage the cone or collet being used. Further, the proximal support ring 22 is mounted offset from the distal support ring 23 by the plurality of elongated spacers 24 to secure the proximal support ring 22 to the distal support ring 23. Furthermore, each of the plurality of elongated spacers 24 is positioned through a corresponding spacer-receiving hole from the plurality of spacer-receiving holes 8 to secure the spring extension 21 to the spacer disk 1. In other embodiments, different mechanisms can be utilized to secure the spring extension 21 or parts of the spring extension 21 to the spacer disk 1.

As can be seen in FIGS. 1 through 12, the integration of the spring extension 21 into the spacer disk 1 facilitates the optimal balancing of the selected wheel using an existing wheel balancer. As the selected wheel is clamped on the wheel balancer shaft using a centering plate 31 and the corresponding plurality of spring-loaded studs 32 with extended nipples, the captured spring is further forced into the wheel balancer hub by the spring extension 21 while the captured spring pushes the cone or collet being used into the wheel bore of the selected wheel. The stud nipples lean on the spacer disk 1, thereby assist the cone or collet with proper and perfect centering of the selected wheel on the wheel balancer. The spacer disk 1 is manufactured in such a way that the support area within the spacer disk 1 is much larger and easy to guide the stud nipples onto. In other embodiments, the spring extension 21 can be altered to engage special designs of the wheel balancer hub.

As can be seen in FIGS. 1 through 12, to accommodate the spring extension 21, the spacer disk 1 may further comprise an annular interfacing recess 9. The annular interfacing recess 9 is designed to accommodate the distal support ring 23 in such a way that the distal support ring 23 is flushed with the external surface of the closed disk base 2. In addition, the annular interfacing recess 9 allows the distal support ring 23 to be pressed against the wheel balancer hub without the user needing to overcome the resistance of the captured spring within the wheel balancer hub. To do so, the annular interfacing recess 9 is positioned external to the spacer disk 1 so that the annular interfacing recess 9 can be integrated into the closed disk base 2. In other words, the annular interfacing recess 9 provides space outside the spacer disk 1 to receive the distal support ring 23. Further, the annular interfacing recess 9 is concentrically positioned with the shaft-receiving hole 7 to axially align the annular interfacing recess 9 with the closed disk base 2. Furthermore, the distal support ring 23 and the plurality of spacer-receiving holes 8 are positioned within the annular interfacing recess 9 so that the spring extension 21 coincides with the annular interfacing recess 9.

As previously disclosed, the plurality of elongated spacers 24 enables the mounting of the spring extension 21 to the spacer disk 1. However, the plurality of elongated spacers 24 do not fully secure the spring extension 21 in place on the spacer disk 1. As can be seen in FIGS. 1 through 12, to fully secure the spring extension 21 to the spacer disk 1, the spacer disk 1 may further comprise a plurality of ring magnets 10 and a plurality of magnet-receiving cavities 11. The plurality of ring magnets 10 enable the removable attachment of the distal support ring 23 to the closed disk base 2, while the plurality of magnet-receiving cavities 11 provide the space to accommodate the plurality of ring magnets 10 on the closed disk base 2. In the preferred embodiment, the plurality of ring magnets 10 can be implemented as follows: the plurality of magnet-receiving cavities 11 traverses into the closed disk base 2 to form spaces on the closed disk base 2 that accommodate the plurality of ring magnets 10. The shape and size of each magnet-receiving cavity matches the shape and size of the corresponding ring magnet. Further, the plurality of magnet-receiving cavities 11 is positioned opposite to the lateral disk wall 4 about the closed disk base 2 so that the plurality of ring magnets 10 can directly engage the distal support ring 23. In addition, the plurality of magnet-receiving cavities 11 is positioned around the shaft-receiving hole 7 and is interspersed amongst the plurality of spacer-receiving holes 8. This way, the distribution of the plurality of ring magnets 10 matches the shape and size of the distal support ring 23 without obstructing the plurality of elongated spacers 24. Further, each of the plurality of ring magnets 10 is connected into a corresponding magnet-receiving cavity from the plurality of magnet-receiving cavities 11 to secure the plurality of ring magnets 10 to the closed disk base 2. Furthermore, the distal support ring 23 is attached adjacent to the closed disk base 2 by the plurality of ring magnets 10 so that spring extension 21 is secured in place on the spacer disk 1.

As can be seen in FIGS. 1 through 12, to secure the spacer disk 1 to the wheel balancer hub, the spacer disk 1 may further comprise a plurality of first hub-attachment mechanisms 12 and a plurality of second hub-attachment mechanisms 13. The plurality of first hub-attachment mechanisms 12 and the plurality of second hub-attachment mechanisms 13 enable the fastening of the spacer disk 1 to the wheel balancer hub so that the spacer disk 1 rotates along with the wheel balancer hub. Fastening the spacer disk 1 to the wheel balancer hub is considered best practice when balancing heavy wheels using leaning studs. In addition, the plurality of first hub-attachment mechanisms 12 and the plurality of second hub-attachment mechanisms 13 enables the plurality of spring-loaded studs 32 on the centering plate 31 engaged through the lug holes of the selected wheel to lean on the spacer disk 1, thereby removing the effects of gravity, improving static centering, and greatly enhancing the balancing results of light duty pickup truck and motorhome wheels. To do so, the plurality of first hub-attachment mechanisms 12 and the plurality of second hub-attachment mechanisms 13 each comprises a plurality of fastening holes 14 that accommodates the appropriate fasteners that can be used to torsionally connect the spacer disk 1 to the wheel balancer hub. The plurality of fastening holes 14 preferably includes several fastening holes of different sizes to accommodate fasteners of different sizes. The plurality of first hub-attachment mechanisms 12 and the plurality of second hub-attachment mechanisms 13 are peripherally positioned on the closed disk base 2 to match the radial distribution of the corresponding fastener holes on the wheel balancer hub.

Further, the plurality of first hub-attachment mechanisms 12 and the plurality of second hub-attachment mechanisms 13 are diametrically opposed to each other about closed disk base 2, as can be seen in FIGS. 1 through 12. This way, the fastening holes of matching sizes are positioned opposite to each other to match the positioning of corresponding fastener holes on the wheel balancer hub. Further, the plurality of fastening holes 14 is configured with a series of incremental hole sizes which are arranged in an arc configuration. The arc configuration is concentrically positioned to the shaft-receiving hole 7. For example, the largest fastening holes can be positioned closer to the shaft-receiving hole 7. In addition, decreasingly smaller fastening holes are positioned further from the shaft-receiving hole 7, and the smallest fastening holes are positioned adjacent to the lateral disk wall 4. Furthermore, each of the plurality of fastening holes 14 traverses through the closed disk base 2 to enable the corresponding fasteners to pass through the closed disk base 2. In other embodiments, different fastening mechanisms can be implemented to torsionally secure the spacer disk 1 to the wheel balancer hub.

As previously discussed, the stud nipples of the corresponding stud being used with the centering plate 31 engage with the spacer disk 1 in such a way that the stud nipples rest on the spacer disk 1 to help center the selected wheel on the wheel balancer shaft. As can be seen in FIGS. 1 through 12, the spacer disk 1 may further comprise a plurality of smaller-stud-engagement features 15. The plurality of smaller-stud-engagement features 15 correspond to stud-engagement features that accommodate smaller wheel sizes. Moreover, the lateral disk wall 4 comprises an inner wall surface 5 corresponding to the internal surface of the lateral disk wall 4. Each of the plurality of smaller-stud-engagement features 15 comprising a plurality of stud-receiving slots 16 corresponding to several radial slots with a shape and size that accommodate the stud nipples engaging the spacer disk 1. The plurality of stud-receiving slots 16 is also designed to accommodate different smaller wheel sizes. To implement the plurality of smaller-stud-engagement features 15, the plurality of smaller-stud-engagement features is integrated into the inner wall surface 5. For example, the plurality of stud-receiving slots 16 can be milled inside the lateral disk wall 4 to form the radial spaces that receive the stud nipples. In addition, the plurality of smaller-stud-engagement features 15 is radially distributed about the lateral disk wall 4 to match the radial distribution of the plurality of spring-loaded studs 32 on the centering plate 31. For example, if five spring-loaded studs are used, the plurality of smaller-stud-engagement features 15 includes five smaller-stud-engagement features to engage the five spring-loaded studs.

Furthermore, the plurality of stud-receiving slots 16 is configured with a series of incremental lateral depths to accommodate several smaller wheel sizes, as can be seen in FIGS. 1 through 12. For example, each of the plurality of smaller-stud-engagement features 15 may include three stud-receiving slots. Each of the three stud-receiving slots has a different Pitch Circle Diameter (PCD). The stud-receiving slot with the largest PCD is positioned first, the stud-receiving slot with the intermediate PCD is positioned next, and the stud-receiving slot with the smallest PCD is positioned last. This way, as the stud nipples are inserted into the spacer disk 1 through the open disk base 3, the stud nipples preferably engage the stud-receiving slots with the largest PCD first. If the PCD of the plurality of spring-loaded studs 32 is smaller than the stud-receiving slots with the largest PCD, the user can rotate the selected wheel so that stud nipples engage the stud-receiving slots with the smaller PCD. Again, if the PCD of the plurality of spring-loaded studs 32 is smaller than the stud-receiving slots with the smaller PCD, the user can rotate the selected wheel again so that stud nipples engage the stud-receiving slots with the smallest PCD. Thus, the user does not have to guess when engaging the plurality of spring-loaded studs 32 with the spacer disk 1. In other embodiments, each of the plurality of smaller-stud-engagement features 15 may include additional stud-receiving slots with smaller PCDs to accommodate additional smaller wheel sizes.

In addition to accommodating smaller wheel sizes, the spacer disk 1 can accommodate larger wheel sizes. As can be seen in FIGS. 1 through 12, the spacer disk 1 may further comprise a plurality of larger-stud-engagement features 17. The plurality of larger-stud-engagement features 17 correspond to stud-engagement features that accommodate the plurality of spring-loaded studs 32 on the centering plate 31 arranged to match larger wheels. Moreover, the lateral disk wall 4 further comprises an outer wall surface 6 corresponding to the external surface of the lateral disk wall 4. To implement the plurality of larger-stud-engagement features 17, the plurality of larger-stud-engagement features 17 is integrated into the outer wall surface 6 due to the PCD of the larger-stud-engagement features being larger than the largest PCD of the smaller-stud-engagement feature. In addition, the plurality of larger-stud-engagement features 17 is radially distributed about the lateral disk wall 4 to match the radial distribution of the plurality of spring-loaded studs 32 on the centering plate 31. Similar to the plurality of smaller-stud-engagement features 15, each of the plurality of larger-stud-engagement features 17 includes at least one stud-receiving slot 18. The at least one stud-receiving slot 18 is designed to accommodate the corresponding stud nipple that is passed through one of the lug holes on the selected wheel. In the preferred embodiment, the at least one stud-receiving slot 18 of each of the plurality of larger-stud-engagement features 17 has the same PCD. However, in other embodiments, each of the plurality of larger-stud-engagement features 17 can include several stud-receiving slots, each with a smaller PCD to accommodate larger wheels of different sizes.

Many wheel balancer shafts are threaded shafts, which can make sliding the spacer disk 1 along the threaded shaft difficult. As can be seen in FIGS. 1 through 12, to facilitate the mounting of the spacer disk 1 onto a threaded shaft, the spacer disk 1 may further comprise a distal filleted rim 19 and a proximal filleted rim 20. The distal filleted rim 19 and the proximal filleted rim 20 provide a larger surface that allows the spacer disk 1 to more easily slide along the threaded shaft. To do so, the distal filleted rim 19 and the proximal filleted rim 20 are perimetrically positioned around the shaft-receiving hole 7 to form a larger cylindrical surface around the shaft-receiving hole 7. Further, the distal filleted rim 19 is connected adjacent to the closed disk base 2, opposite to the lateral disk wall 4, to integrate the distal filleted rim 19 on the exterior surface of the closed disk base 2 around the shaft-receiving hole 7. Similarly, the proximal filleted rim is connected adjacent to the closed disk base 2, opposite to the distal filleted rim 19, to integrated the proximal filleted rim 20 on the interior surface of the closed disk base 2 around the shaft-receiving hole 7. Thus, a larger cylindrical surface is formed around the shaft-receiving hole 7 to allow the spacer disk 1 to easily slide along the threaded shaft. In other embodiments, different mechanisms can be implemented to facilitate the mounting of the spacer disk 1 to the wheel balancer shaft.

As previously discussed, the system of the present invention allows a low-tapered cone or collet to be used to help center the selected wheel on the wheel balancer shaft. So, the present invention may further comprise at least one centering collet 25, as can be seen in FIGS. 1 through 12. The at least one centering collet 25 is designed to engage the wheel bore of the selected wheel to help center the selected wheel on the wheel balancer shaft. The at least one centering collet 25 is made to the highest possible accuracy and with the smoothest surface finish. The low taper requires a super fine surface finish in order to avoid sticking inside the wheel bore. Further, the at least one centering collet 25 is plated and extremely rust-resistant even in very humid environments. The at least one centering collet 25 is relatively lightweight and features a built-in handle, making the at least one centering collet 25 easy to grip, install, and remove from the balancing machine. To do so, the at least one centering collet 25 comprises a closed collet base 26, an open collet base 27, a lateral collet wall 28, and a shaft-receiving sleeve 29. The closed collet base 26 corresponds to the portion of the at least one centering collet 25 that engages the spring extension 21. The open collet base 27 corresponds to the portion that engages the wheel bore of the selected wheel. The lateral collet wall 28 corresponds to side structure that connects the open collet base 27 to the closed collet base 26. Further, the shaft-receiving sleeve 29 corresponds to the structure that facilitates the mounting of the at least one centering collet 25 to the wheel balancer shaft. Similar to the distal filleted rim 19 and the proximal filleted rim 20, the shaft-receiving sleeve 29 provides a large cylindrical surface that prevents the external threading on the wheel balancer shaft from stopping the movement of the at least one centering collet 25 along the length of the wheel balancer shaft. The shaft-receiving sleeve 29 also serves as the built-in handle to enable the user to maneuver the at least one centering collet 25.

In the preferred embodiment, the at least one centering collet 25 can be arranged as follows: the closed collet base 26 and the open collet base 27 are positioned opposite to each other about the lateral collet wall 28 due to the overall short cylindrical structure of the at least one centering collet 25, as can be seen in FIGS. 1 through 12. The shaft-receiving sleeve 29 is also positioned in between the closed collet base 26 and the open collet base 27 to form a single solid structure. Further, the shaft-receiving sleeve 29 is centrally connected through the closed collet base 26 to integrate the shaft-receiving sleeve 29 within the lateral collet wall 28. In addition, the shaft-receiving sleeve 29 and the lateral collet wall 28 are concentrically positioned with the shaft-receiving hole 7 to axially align the shaft-receiving sleeve 29 and the lateral collet wall 28 to the wheel balancer shaft. Furthermore, the closed collet base 26 is mounted against the proximal support ring 22 when the at least one centering collet 25 is mounted onto the wheel balancer shaft to center the selected wheel.

Like the spacer disk 1, the at least one centering collet 25 is designed to accommodate wheels of different sizes. As can be seen in FIGS. 1 through 12, the at least one centering collet 25 may further comprise a plurality of bore-engagement features 30 that enables the at least one centering collet 25 to engage the wheel bore of wheels of different sizes. In the preferred embodiment, the closed collet base 26 is diametrically larger than the open collet base 27 due to the low-tapered design of the at least one centering collet 25. In addition, the plurality of bore-engagement features 30 is laterally integrated around the lateral collet wall 28. The plurality of bore-engagement features 30 corresponds to outer rings of different diameters that match wheel bores of different sizes. The plurality of bore-engagement features 30 is also configured as a plurality of step-up features from the open collet base 27 to the closed collet base 26. This way, when the at least one centering collet 25 is engaged into the wheel bore of the selected wheel, the wheel bore first engages the bore-engagement feature adjacent to the open collet base 27. As the stud nipples of the plurality of spring-loaded studs 32 on the centering plate 31 engage the spacer disk 1 through the lug holes of the selected wheel, the wheel bore moves up the bore-engagement features until the wheel bore engages the bore-engagement feature of matching size. Further, as the captured spring in the wheel balancer hub pushes the spring extension 21 back towards the at least one centering collet 25, the at least one centering collet 25 is forced into the wheel bore of the selected wheel. Thus, the system of the present invention further facilitates the mounting and centering of the selected wheel on the wheel balancer shaft.

As can be seen in FIGS. 1 through 12, in some embodiments, the bore-engagement feature adjacent to the open collet base 27 corresponds to an oversized “rest-stop” that enables heavy wheels to rest securely on the at least one centering collet 25 without the risk of dropping onto the wheel balancer shaft. In addition, large extended lips can be incorporated around the open collet base 27 and the closed collet base 26 to ensure that the at least one centering collet 25 can be dropped without the crucial low-taper step-up features colliding with the concrete floor. The crucial low-taper step-up features are machined to a surface finish better than Ra24″, ensuring that the selected wheel can easily slide up on the step-up features for optimal centering and balancing results. In other embodiments, different collet designs may be implemented to accommodate special wheel designs.

As can be seen in FIGS. 1 through 12, in some embodiments, the system of the present invention may further include a centering plate 31 and a plurality of spring-loaded studs 32. The centering plate 31 is a lightweight plate with a plurality of stud holes distributed radially and along the centering plate 31. For example, the centering plate 31 can be an Aluminum plate that is hard anodized for durability. Each stud hole is clearly marked and color-coded to facilitate fast insertion of the plurality of spring-loaded studs 32. The color coding also ensures that each of the plurality of spring-loaded studs 32 is placed into the correct stud hole on the first attempt, saving time and avoiding frustration. The plurality of stud holes are distributed along the centering plate 31 to cover several bolt patterns of different wheel sizes. Further, the plurality of spring-loaded studs 32 includes several spring-loaded studs that are also through-hardened, machined in hard condition, and then further surface-hardened for durability in case of impact with a concrete floor. Each of the plurality of spring-loaded studs 32 includes an enlarged base that enhances the durability of the centering plate 31, providing additional protection in case of a drop on the floor. Further, some spring-loaded studs of the plurality of spring-loaded studs 32 includes an OSB feature that facilitates the engagement of the spring-loaded stud into the corresponding stud hole on the centering plate 31. Furthermore, a wing nut and a bushing can be used to fully fasten the system to the wheel balancer hub to safely proceed with the balancing process using the wheel balancer. In other embodiments, different clamping tools can be utilized to secure the selected wheel to the spacer disk 1.

Although the invention has been explained in relation to its preferred embodiment, it is to be understood that many other possible modifications and variations can be made without departing from the spirit and scope of the invention.

What is claimed is:

1. A universal mounting system for a wheel balancer comprising:
a spacer disk;
a spring extension;
the spacer disk comprising a closed disk base, an open disk base, a lateral disk wall, a shaft-receiving hole, and a plurality of spacer-receiving holes;
the spring extension comprising a proximal support ring, a distal support ring, and a plurality of elongated spacers;
the closed disk base and the open disk base being positioned opposite to each other about the lateral disk wall;
the shaft-receiving hole and each of the plurality of spacer-receiving holes traversing through the closed disk base;
the shaft-receiving hole being centrally positioned on the closed disk base;
the plurality of spacer-receiving holes being positioned around the shaft-receiving hole;
the distal support ring and the proximal support ring being concentrically positioned to the shaft-receiving hole;
the distal support ring being positioned external to the spacer disk;
the distal support ring being mounted adjacent to the closed disk base;
the proximal support ring being positioned within the spacer disk;
the proximal support ring being mounted offset from the distal support ring by the plurality of elongated spacers; and
each of the plurality of elongated spacers being positioned through a corresponding spacer-receiving hole from the plurality of spacer-receiving holes.

2. The universal mounting system for a wheel balancer as claimed in claim 1 further comprising:
the spacer disk further comprising an annular interfacing recess;
the annular interfacing recess being positioned external to the spacer disk;
the annular interfacing recess being integrated into the closed disk base;
the annular interfacing recess being concentrically positioned with the shaft-receiving hole; and
the distal support ring and the plurality of spacer-receiving holes being positioned within the annular interfacing recess.

3. The universal mounting system for a wheel balancer as claimed in claim 1 further comprising:
the spacer disk further comprising a plurality of ring magnets and a plurality of magnet-receiving cavities;
the plurality of magnet-receiving cavities traversing into the closed disk base;
the plurality of magnet-receiving cavities being positioned opposite to the lateral disk wall about the closed disk base;
the plurality of magnet-receiving cavities being positioned around the shaft-receiving hole;
the plurality of magnet-receiving cavities being interspersed amongst the plurality of spacer-receiving holes;
each of the plurality of ring magnets being connected into a corresponding magnet-receiving cavity from the plurality of magnet-receiving cavities; and
the distal support ring being attached adjacent to the closed disk base by the plurality of ring magnets.

4. The universal mounting system for a wheel balancer as claimed in claim 1 further comprising:
the spacer disk further comprising a plurality of first hub-attachment mechanisms and a plurality of second hub-attachment mechanisms;
the plurality of first hub-attachment mechanisms and the plurality of second hub-attachment mechanisms each comprising a plurality of fastening holes;
the plurality of first hub-attachment mechanisms and the plurality of second hub-attachment mechanisms being peripherally positioned on the closed disk base;
the plurality of first hub-attachment mechanisms and the plurality of second hub-attachment mechanisms being diametrically opposed to each other about closed disk base;
the plurality of fastening holes being configured with a series of incremental hole sizes;
the plurality of fastening holes being arranged in an arc configuration;
the arc configuration being concentrically positioned to the shaft-receiving hole; and
each of the plurality of fastening holes traversing through the closed disk base.

5. The universal mounting system for a wheel balancer as claimed in claim 1 further comprising:
the spacer disk further comprising a plurality of smaller-stud-engagement features;
the lateral disk wall comprising an inner wall surface;
each of the plurality of smaller-stud-engagement features comprising a plurality of stud-receiving slots;
the plurality of smaller-stud-engagement features being integrated into the inner wall surface;
the plurality of smaller-stud-engagement features being radially distributed about the lateral disk wall; and
the plurality of stud-receiving slots being configured with a series of incremental lateral depths.

6. The universal mounting system for a wheel balancer as claimed in claim 1 further comprising:
the spacer disk further comprising a plurality of larger-stud-engagement features;
the lateral disk wall comprising an outer wall surface;
the plurality of larger-stud-engagement features being integrated into the outer wall surface; and
the plurality of larger-stud-engagement features being radially distributed about the lateral disk wall.

7. The universal mounting system for a wheel balancer as claimed in claim 6, wherein each of the plurality of larger-stud-engagement features includes at least one stud-receiving slot.

8. The universal mounting system for a wheel balancer as claimed in claim 1 further comprising:
the spacer disk further comprising a distal filleted rim and a proximal filleted rim;
the distal filleted rim and the proximal filleted rim being perimetrically positioned around the shaft-receiving hole;
the distal filleted rim being connected adjacent to the closed disk base, opposite to the lateral disk wall; and
the proximal filleted rim being connected adjacent to the closed disk base, opposite to the distal filleted rim.

9. The universal mounting system for a wheel balancer as claimed in claim 1 further comprising:
at least one centering collet;
the at least one centering collet comprising a closed collet base, an open collet base, a lateral collet wall, and a shaft-receiving sleeve;
the closed collet base and the open collet base being positioned opposite to each other about the lateral collet wall;
the shaft-receiving sleeve being positioned in between the closed collet base and the open collet base;
the shaft-receiving sleeve being centrally connected through the closed collet base;
the shaft-receiving sleeve and the lateral collet wall being concentrically positioned with the shaft-receiving hole; and
the closed collet base being mounted against the proximal support ring.

10. The universal mounting system for a wheel balancer as claimed in claim 9 further comprising:
the at least one centering collet further comprising a plurality of bore-engagement features;
the closed collet base being diametrically larger than the open collet base;
the plurality of bore-engagement features being laterally integrated around the lateral collet wall; and
the plurality bore-engagement features being configured as a plurality of step-up features from the open collet base to the closed collet base.

11. A universal mounting system for a wheel balancer comprising:
a spacer disk;
a spring extension;
the spacer disk comprising a closed disk base, an open disk base, a lateral disk wall, a shaft-receiving hole, a plurality of spacer-receiving holes, and an annular interfacing recess;
the spring extension comprising a proximal support ring, a distal support ring, and a plurality of elongated spacers;
the closed disk base and the open disk base being positioned opposite to each other about the lateral disk wall;
the shaft-receiving hole and each of the plurality of spacer-receiving holes traversing through the closed disk base;
the shaft-receiving hole being centrally positioned on the closed disk base;
the plurality of spacer-receiving holes being positioned around the shaft-receiving hole;
the distal support ring and the proximal support ring being concentrically positioned to the shaft-receiving hole;
the distal support ring being positioned external to the spacer disk;
the distal support ring being mounted adjacent to the closed disk base;
the proximal support ring being positioned within the spacer disk;
the proximal support ring being mounted offset from the distal support ring by the plurality of elongated spacers;
each of the plurality of elongated spacers being positioned through a corresponding spacer-receiving hole from the plurality of spacer-receiving holes;
the annular interfacing recess being positioned external to the spacer disk;
the annular interfacing recess being integrated into the closed disk base;
the annular interfacing recess being concentrically positioned with the shaft-receiving hole; and
the distal support ring and the plurality of spacer-receiving holes being positioned within the annular interfacing recess.

12. The universal mounting system for a wheel balancer as claimed in claim 11 further comprising:
the spacer disk further comprising a plurality of ring magnets and a plurality of magnet-receiving cavities;
the plurality of magnet-receiving cavities traversing into the closed disk base;
the plurality of magnet-receiving cavities being positioned opposite to the lateral disk wall about the closed disk base;
the plurality of magnet-receiving cavities being positioned around the shaft-receiving hole;
the plurality of magnet-receiving cavities being interspersed amongst the plurality of spacer-receiving holes;
each of the plurality of ring magnets being connected into a corresponding magnet-receiving cavity from the plurality of magnet-receiving cavities; and
the distal support ring being attached adjacent to the closed disk base by the plurality of ring magnets.

13. The universal mounting system for a wheel balancer as claimed in claim 11 further comprising:
the spacer disk further comprising a plurality of first hub-attachment mechanisms and a plurality of second hub-attachment mechanisms;
the plurality of first hub-attachment mechanisms and the plurality of second hub-attachment mechanisms each comprising a plurality of fastening holes;
the plurality of first hub-attachment mechanisms and the plurality of second hub-attachment mechanisms being peripherally positioned on the closed disk base;
the plurality of first hub-attachment mechanisms and the plurality of second hub-attachment mechanisms being diametrically opposed to each other about closed disk base;
the plurality of fastening holes being configured with a series of incremental hole sizes;
the plurality of fastening holes being arranged in an arc configuration;
the arc configuration being concentrically positioned to the shaft-receiving hole; and
each of the plurality of fastening holes traversing through the closed disk base.

14. The universal mounting system for a wheel balancer as claimed in claim 11 further comprising:
the spacer disk further comprising a plurality of smaller-stud-engagement features and a plurality of larger-stud-engagement features;
the lateral disk wall comprising an inner wall surface and an outer wall surface;
each of the plurality of smaller-stud-engagement features comprising a plurality of stud-receiving slots;
the plurality of smaller-stud-engagement features being integrated into the inner wall surface;
the plurality of smaller-stud-engagement features being radially distributed about the lateral disk wall;
the plurality of stud-receiving slots being configured with a series of incremental lateral depths;
each of the plurality of larger-stud-engagement features including at least one stud-receiving slot;
the plurality of larger-stud-engagement features being integrated into the outer wall surface; and
the plurality of larger-stud-engagement features being radially distributed about the lateral disk wall.

15. The universal mounting system for a wheel balancer as claimed in claim 11 further comprising:
the spacer disk further comprising a distal filleted rim and a proximal filleted rim;
the distal filleted rim and the proximal filleted rim being perimetrically positioned around the shaft-receiving hole;
the distal filleted rim being connected adjacent to the closed disk base, opposite to the lateral disk wall; and
the proximal filleted rim being connected adjacent to the closed disk base, opposite to the distal filleted rim.

16. The universal mounting system for a wheel balancer as claimed in claim 11 further comprising:
at least one centering collet;
the at least one centering collet comprising a closed collet base, an open collet base, a lateral collet wall, a shaft-receiving sleeve, and a plurality of bore-engagement features;
the closed collet base being diametrically larger than the open collet base;
the closed collet base and the open collet base being positioned opposite to each other about the lateral collet wall;
the shaft-receiving sleeve being positioned in between the closed collet base and the open collet base;
the shaft-receiving sleeve being centrally connected through the closed collet base;
the shaft-receiving sleeve and the lateral collet wall being concentrically positioned with the shaft-receiving hole;
the closed collet base being mounted against the proximal support ring;
the plurality of bore-engagement features being laterally integrated around the lateral collet wall; and
the plurality bore-engagement features being configured as a plurality of step-up features from the open collet base to the closed collet base.

17. A universal mounting system for a wheel balancer comprising:
a spacer disk;
a spring extension;
the spacer disk comprising a closed disk base, an open disk base, a lateral disk wall, a shaft-receiving hole, a plurality of spacer-receiving holes, an annular interfacing recess, a distal filleted rim, a proximal filleted rim, a plurality of ring magnets, and a plurality of magnet-receiving cavities;
the spring extension comprising a proximal support ring, a distal support ring, and a plurality of elongated spacers;
the closed disk base and the open disk base being positioned opposite to each other about the lateral disk wall;
the shaft-receiving hole and each of the plurality of spacer-receiving holes traversing through the closed disk base;
the shaft-receiving hole being centrally positioned on the closed disk base;
the plurality of spacer-receiving holes being positioned around the shaft-receiving hole;
the distal support ring and the proximal support ring being concentrically positioned to the shaft-receiving hole;
the distal support ring being positioned external to the spacer disk;
the distal support ring being mounted adjacent to the closed disk base;
the proximal support ring being positioned within the spacer disk;
the proximal support ring being mounted offset from the distal support ring by the plurality of elongated spacers;
each of the plurality of elongated spacers being positioned through a corresponding spacer-receiving hole from the plurality of spacer-receiving holes;
the annular interfacing recess being positioned external to the spacer disk;
the annular interfacing recess being integrated into the closed disk base;
the annular interfacing recess being concentrically positioned with the shaft-receiving hole;
the distal support ring and the plurality of spacer-receiving holes being positioned within the annular interfacing recess;
the distal filleted rim and the proximal filleted rim being perimetrically positioned around the shaft-receiving hole;
the distal filleted rim being connected adjacent to the closed disk base, opposite to the lateral disk wall;
the proximal filleted rim being connected adjacent to the closed disk base, opposite to the distal filleted rim;
the plurality of magnet-receiving cavities traversing into the closed disk base;
the plurality of magnet-receiving cavities being positioned opposite to the lateral disk wall about the closed disk base;
the plurality of magnet-receiving cavities being positioned around the shaft-receiving hole;
the plurality of magnet-receiving cavities being interspersed amongst the plurality of spacer-receiving holes;
each of the plurality of ring magnets being connected into a corresponding magnet-receiving cavity from the plurality of magnet-receiving cavities; and
the distal support ring being attached adjacent to the closed disk base by the plurality of ring magnets.

18. The universal mounting system for a wheel balancer as claimed in claim 17 further comprising:
the spacer disk further comprising a plurality of first hub-attachment mechanisms and a plurality of second hub-attachment mechanisms;
the plurality of first hub-attachment mechanisms and the plurality of second hub-attachment mechanisms each comprising a plurality of fastening holes;
the plurality of first hub-attachment mechanisms and the plurality of second hub-attachment mechanisms being peripherally positioned on the closed disk base;
the plurality of first hub-attachment mechanisms and the plurality of second hub-attachment mechanisms being diametrically opposed to each other about closed disk base;
the plurality of fastening holes being configured with a series of incremental hole sizes;
the plurality of fastening holes being arranged in an arc configuration;
the arc configuration being concentrically positioned to the shaft-receiving hole; and
each of the plurality of fastening holes traversing through the closed disk base.

19. The universal mounting system for a wheel balancer as claimed in claim 17 further comprising:
the spacer disk further comprising a plurality of smaller-stud-engagement features and a plurality of larger-stud-engagement features;
the lateral disk wall comprising an inner wall surface and an outer wall surface;
each of the plurality of smaller-stud-engagement features comprising a plurality of stud-receiving slots;
the plurality of smaller-stud-engagement features being integrated into the inner wall surface;
the plurality of smaller-stud-engagement features being radially distributed about the lateral disk wall;
the plurality of stud-receiving slots being configured with a series of incremental lateral depths;
each of the plurality of larger-stud-engagement features including at least one stud-receiving slot;
the plurality of larger-stud-engagement features being integrated into the outer wall surface; and
the plurality of larger-stud-engagement features being radially distributed about the lateral disk wall.

20. The universal mounting system for a wheel balancer as claimed in claim 17 further comprising:
at least one centering collet;
the at least one centering collet comprising a closed collet base, an open collet base, a lateral collet wall, a shaft-receiving sleeve, and a plurality of bore-engagement features;
the closed collet base being diametrically larger than the open collet base;
the closed collet base and the open collet base being positioned opposite to each other about the lateral collet wall;
the shaft-receiving sleeve being positioned in between the closed collet base and the open collet base;
the shaft-receiving sleeve being centrally connected through the closed collet base;
the shaft-receiving sleeve and the lateral collet wall being concentrically positioned with the shaft-receiving hole;
the closed collet base being mounted against the proximal support ring;
the plurality of bore-engagement features being laterally integrated around the lateral collet wall; and
the plurality bore-engagement features being configured as a plurality of step-up features from the open collet base to the closed collet base.
